(19) United States
(12) Patent Application Publication
(10) Pub. No.: US 2009/0148356 A1
(43) Pub. Date: Jun. 11, 2009

(54) HOLDING MEMBER TO HOLD EXHAUST GAS TREATING ELEMENT AND EXHAUST GAS TREATING DEVICE INCLUDING THE HOLDING MEMBER

(75) Inventor: Takahiko OKABE, Aichi (JP)

Correspondence Address: DITTHAVONG MORI & STEINER, P.C., 918 Prince St., Alexandria, VA, 22314, US

(73) Assignee: IBIDEN CO., LTD., Ogaki-shi (JP)

(21) Appl. No.: 12/327,454

(22) Filed: Dec. 3, 2008

(30) Foreign Application Priority Data
Dec. 5, 2007 (JP) 2007-315052
Oct. 3, 2008 (JP) 2008-259077

(51) Int. Cl. B01J 19/00

(52) U.S. Cl. 422/179

(57) ABSTRACT

A holding member is provided to hold in a housing an exhaust gas treating element through which an exhaust gas is configured to flow from an inlet to an outlet in a flowing direction. The holding member includes a first inorganic fiber layer and a second inorganic fiber layer. The first inorganic fiber layer is to be wrapped around the exhaust gas treating element. The first inorganic fiber layer has a first length along the flowing direction. The second inorganic fiber layer is provided on the first inorganic fiber layer. The second inorganic fiber layer has a second length along the flowing direction which is longer than the first length.

### CROSS-REFERENCE TO RELATED APPLICATION

The present application claims priority under 35 U.S.C. §119 to Japanese patent application No. 2007-315052 filed on Dec. 5, 2007 and Japanese patent application No. 2008-259077 filed on Oct. 3, 2008. The contents of these applications are incorporated herein by reference in their entirety.

### BACKGROUND OF THE INVENTION

1. Field of the Invention

The present invention relates to a holding member to hold an exhaust gas treating element in a housing, and an exhaust gas treating device including the holding member.

2. Description of the Related Art

For example, JP-A-10-141052 describes a holding member and an exhaust gas treating device, in which a metal external cylinder installed therein a ceramic catalyst support through a holding member therebetwen. The contents of JP-A-10-141052 are incorporated herein by reference in their entirety.

As shown in FIG. 30, in the exhaust gas treating device 200 described in JP-A-10-141052, a holding member 202 is attached to the outer periphery of a ceramic catalyst support 201, the support is inserted into an external cylinder 203 having an inner diameter slightly smaller than the outer diameter of the holding member 202 attached, and the diameter of the external cylinder 203 is entirely contracted with a taper deformation until the holding member 202 can have a predetermined surface pressure.

An exhaust gas treating device fixed on an exhaust gas flow path so as to remove components harmful to humans, such as nitrogen oxide, hydrocarbon compound and carbon monoxide contained in the exhaust gas components of an internal combustion engine, usually includes an exhaust gas treating element such as catalyst support or DPF catalyst, a metal housing for housing the treating element, and a holding member for elastically holding the exhaust gas treating element within the housing.

The holding member is required to exhibit a function of preventing a damage or the like caused resulting from interference of the exhaust gas treating element with the metal housing due to vibration or the like of the internal combustion engine and at the same time, preventing an unpurified exhaust gas from leaking out from between the metal housing and the exhaust gas treating element by being disposed elastically between the metal housing and the exhaust gas treating element.

However, with recent strict regulations regarding an exhaust gas and a fuel, the exhaust gas temperature tends to become higher, and an expansive holding member using vermiculite sometimes dose not have sufficient heat resistance.

To cope with this, a non-expansive mat-type holding member formed of a polycrystalline alumina fiber comes into use. The holding member formed of a polycrystalline alumina fiber is bulky and therefore, is generally subjected to a needling treatment for improving the installation property when installing the holding member between a metal housing and an exhaust gas treating element.

For example, if the holding member is used for DPF, in order to hold an exhaust gas treating element having a large weight by an alumina fiber holding member, it is necessary to increase the surface pressure developed in the holding member. Then, in order to increase the developed surface pressure, the Gap Bulk Density (GBD) of the holding member packed between the exhaust gas treating element and the metal housing needs to be made larger (generally, the gap bulk density is from 0.2 to 0.6 g/cm³ and as the gap bulk density increases, the developed surface pressure becomes large).

At this time, when the gap bulk density becomes 0.5 g/cm³ or more, fiber crush of the holding member gradually starts to shorten the fiber length. Accordingly, in an exhaust gas treating device where the gap bulk density of the holding member is increased to 0.5 g/cm³ or more so as to hold an exhaust gas treating element having a large weight, the fiber length becomes short. And, in the case of an exhaust pipe shape causing an exhaust gas to directly hit the end part of the holding member, the fiber of the holding member may be subject to eolian erosion.

On the other hand, a holding member produced by a papermaking method using a mixture of ceramic fiber and vermiculite is inferior to that formed of an alumina fiber in the eolian erosion performance. Therefore, an attempt is being made to improve the eolian erosion performance by adding a holding member sheet from an alumina fiber along the longitudinal direction of the holding member above.

However, under an exhaust gas temperature of 700° C. or more, the expansive holding member may be reduced in the holding power due to heat deterioration of vermiculite. Accordingly, in a range under high temperature of 700° C. or more such as directly below an engine, use of a holding member formed of alumina fiber is preferred.

### SUMMARY OF THE INVENTION

According to one aspect of the present invention, a holding member is provided to hold in a housing an exhaust gas treating element through which an exhaust gas is configured to flow from an inlet to an outlet in a flowing direction. The holding member includes a first inorganic fiber layer and a second inorganic fiber layer. The first inorganic fiber layer is to be wrapped around the exhaust gas treating element. The first inorganic fiber layer has a first length along the flowing direction. The second inorganic fiber layer is provided on the first inorganic fiber layer. The second inorganic fiber layer has a second length along the flowing direction which is longer than the first length.

According to another aspect of the present invention, a holding member is provided to hold in a housing an exhaust gas treating element through which an exhaust gas is configured to flow from an inlet to an outlet in a flowing direction. The holding member includes an inorganic fiber sheet. The inorganic fiber sheet has a first end part and a second end part opposite to the first end part along a longitudinal direction of the inorganic fiber sheet. The inorganic fiber sheet is to be wound from the first end part along the longitudinal direction around an outer periphery of the exhaust gas treating element to form at least two layers of the inorganic fiber sheet. The first end part has a first length along the flowing direction. The second end part has a second length along the flowing direction which is different from the first length.

According to further aspect of the present invention, a holding member is provided to hold in a housing an exhaust gas treating element through which an exhaust gas is configured to flow from an inlet to an outlet in a flowing direction. The holding member includes an inorganic fiber sheet. The inorganic fiber sheet has a first end part and a second end part opposite to the first end part along a longitudinal direction of the inorganic fiber sheet. The inorganic fiber sheet is to be wound from the first end part along the longitudinal direction around an outer periphery of the exhaust gas treating element to form at least two layers of the inorganic fiber sheet. The first end part has a first length along the flowing direction. The second end part has a second length along the flowing direction which is substantially equal to the first length.

According to the other aspect of the present invention, an exhaust gas treating device includes an exhaust gas treating element, a housing, and a holding member. Through the exhaust gas treating element, an exhaust gas is configured to flow from an inlet to an outlet in a flowing direction. The housing houses the exhaust gas treating element. The holding member is wound around at least a part of an outer periphery of the exhaust gas treating element to hold the exhaust gas treating element in the housing. The holding member includes a first inorganic fiber layer and a second inorganic fiber layer. The first inorganic fiber layer is wound around the exhaust gas treating element. The first inorganic fiber layer has a first length along the flowing direction. The second inorganic fiber layer is provided on the first inorganic fiber layer. The second inorganic fiber layer has a second length along the flowing direction which is longer than the first length. The second inorganic fiber layer has an end part provided at a side of the inlet. The end part is bent to the first inorganic fiber layer when the holding member is provided in the housing.

According to yet the other aspect of the present invention, an exhaust gas treating device includes an exhaust gas treating element, a housing, and a holding member. Through the exhaust gas treating element, an exhaust gas is configured to flow from an inlet to an outlet in a flowing direction. The housing houses the exhaust gas treating element. The holding member is wound around at least a part of an outer periphery of the exhaust gas treating element to hold the exhaust gas treating element in the housing. The holding member includes an inorganic fiber sheet. The inorganic fiber sheet has a first end part and a second end part opposite to the first end part along a longitudinal direction of the inorganic fiber sheet. The inorganic fiber sheet is wound from the first end part along the longitudinal direction around an outer periphery of the exhaust gas treating element to form at least two layers of the inorganic fiber sheet. The first end part has a first length along the flowing direction. The second end part has a second length along the flowing direction which is different from the first length. An end part of a second layer of the inorganic fiber sheet is deformed.

According to yet another aspect of the present invention, an exhaust gas treating device includes an exhaust gas treating element, a housing, and an inorganic fiber sheet. Through the exhaust gas treating element, an exhaust gas is configured to flow from an inlet to an outlet in a flowing direction. The housing houses the exhaust gas treating element. The inorganic fiber sheet is spirally wound around the exhaust gas treating element to hold the exhaust gas treating element in the housing while an end portion along the flowing direction of the inorganic fiber sheet is displaced by a specific length toward an axis of the exhaust gas treating element.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an exploded perspective view of the holding member according to the first embodiment of the present invention;

FIG. 2 is a partially broken appearance perspective view where the holding member of FIG. 1 is installed on a catalyst carrier;

FIG. 3 is a longitudinal cross-sectional view of the exhaust gas treating device according to the first embodiment of the present invention;

FIG. 4 is an enlarged view showing main parts of the exhaust gas treating device of FIG. 3;

FIG. 5 is an exploded perspective view of the holding member according to the second embodiment of the present invention;

FIG. 6 is a longitudinal cross-sectional view of the exhaust gas treating device according to the second embodiment of the present invention;

FIG. 7 is an exploded perspective view of the holding member according to the third embodiment of the present invention;

FIG. 8 is a longitudinal cross-sectional view of the exhaust gas treating device according to the third embodiment of the present invention;

FIG. 9 is an enlarged view showing main parts of the exhaust gas treating device of FIG. 8;

FIG. 10 is an exploded perspective view of the holding member according to the fourth embodiment of the present invention;

FIG. 11 is a longitudinal cross-sectional view of the exhaust gas treating device according to the fourth embodiment of the present invention;

FIG. 12 is an enlarged view showing main parts of the exhaust gas treating device of FIG. 11;

FIGS. 13A and 13B are perspective views of the holding members according to the fifth embodiment of the present invention;

FIG. 14 is an appearance perspective view where the holding member of FIG. 13B is installed on a catalyst carrier;

FIG. 15 is an enlarged view showing main parts of the exhaust gas treating device of FIG. 14;

FIG. 16 is a perspective view of the holding member according to the sixth embodiment of the present invention;

FIG. 17 is an appearance perspective view where the holding member of FIG. 16 is installed on a catalyst carrier;

FIG. 18 is a perspective view of a first modification example of the holding member according to the sixth embodiment of the present invention;

FIG. 19 is an appearance perspective view where the holding member of FIG. 18 is installed on a catalyst carrier;

FIG. 20 is a perspective view of a second modification example of the holding member according to the sixth embodiment of the present invention;

FIG. 21 is an appearance perspective view where the holding member of FIG. 20 is installed on a catalyst carrier;

FIG. 22 is a perspective view of the holding member according to the seventh embodiment of the present invention;

FIG. 23 is an appearance perspective view where the holding member of FIG. 22 is installed on a catalyst carrier;

FIG. 24 is a perspective view of a first modification example of the holding member according to the seventh embodiment of the present invention;

FIG. 25 is an appearance perspective view where the holding member of FIG. 24 is installed on a catalyst carrier;

FIG. 26 is a perspective view of a second modification example of the holding member according to the seventh embodiment of the present invention;

FIG. 27 is an appearance perspective view where the holding member of FIG. 26 is installed on a catalyst carrier;

FIG. 28 is a front view of the pressure surface measuring apparatus used in Examples;

FIG. 29 is a graph showing the evaluation of surface pressure and eolian erosion; and

FIG. 30 is a cross-sectional view of a conventional exhaust gas treating device.

### DETAILED DESCRIPTION

Embodiments will now be described with reference to the accompanying drawings, wherein like reference numerals designate corresponding or identical elements throughout the various drawings.

### First Embodiment

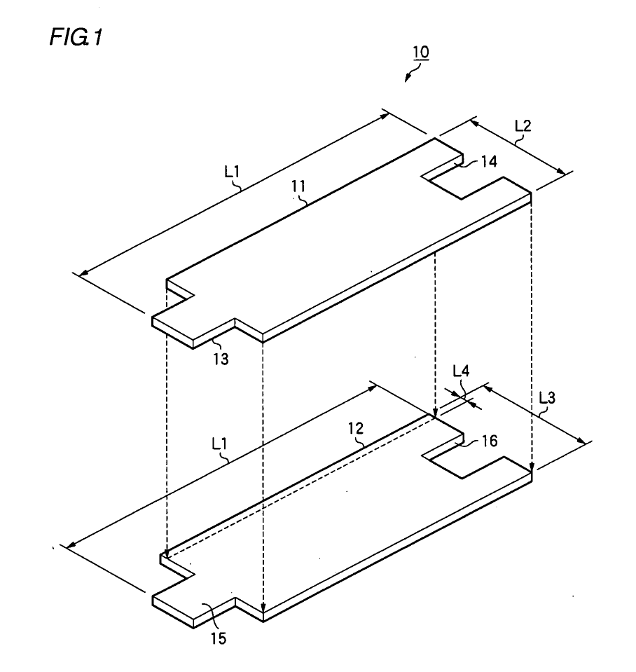

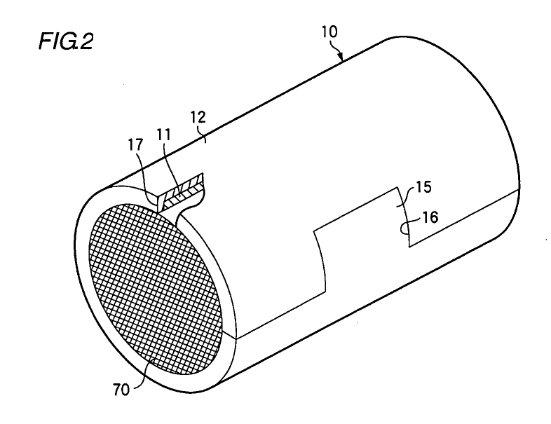

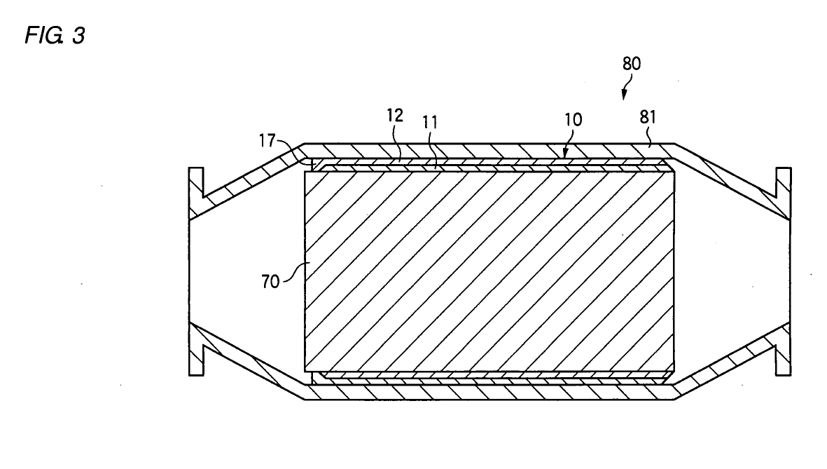

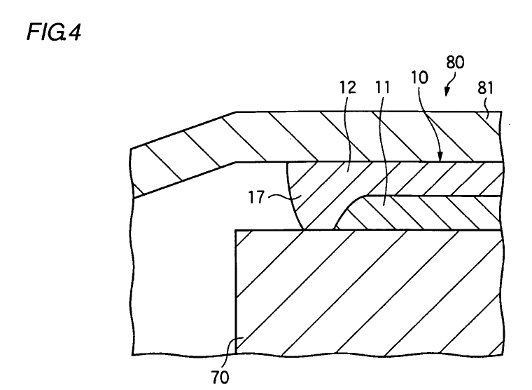

FIGS. 1 to 4 show the holding member and exhaust gas treating device according to the first embodiment of the present invention. FIG. 1 is an exploded perspective view of the holding member according to the first embodiment of the present invention, FIG. 2 is a partially broken appearance perspective view where the holding member of FIG. 1 is installed on a catalyst carrier, FIG. 3 is a longitudinal cross-sectional view of the exhaust gas treating device according to the first embodiment of the present invention, and FIG. 4 is an enlarged view showing main parts of the exhaust gas treating device of FIG. 3.

As shown in FIG. 1, the holding member 10 is obtained by stacking a first sheet member (layer A) 11 and a second sheet member (layer B) 12.

The first sheet member 11 is formed, for example, by punching into a length dimension L1 of 440 mm and a width dimension L2 of 110 mm, where an engaging protrusion part 13 is formed in one end part and an engaging recess part 14 is formed in another end part.

As for the first sheet member 11, a silica sol is blended with an aqueous basic aluminum chloride solution having an aluminum content of 70 g/l and Al/Cl=1.8 (atomic ratio) to have an alumina-based fiber composition of Al₂O₃:SiO₂=72:28, thereby forming an alumina-based fiber precursor. Subsequently, an organic polymer such as polyvinyl alcohol is added and after concentrating the resulting solution to prepare a spinning solution, spinning is performed by a blowing method using the spinning solution. The spun fibers are folded in a stacked state to form an alumina-based fiber sheet member. The obtained sheet member is continuously fired from an ordinary temperature to a maximum temperature of 120° C. to form a first sheet member formed of an alumina-based fiber. Also, the resin content after drying is set to 5% by attaching an acrylic latex emulsion as a binder.

The second sheet member 12 is formed, for example, by punching into a length dimension L1 of 440 mm and a width dimension L3 of 120 mm to be larger on one side than the first sheet member 11 by a specific width dimension L4 of 10 mm. Also, an engaging protrusion part 15 is formed in one end part and an engaging recess part 16 is formed in another end part.

As for the second sheet member 12, a silica sol is blended with an aqueous basic aluminum chloride solution having an aluminum content of 70 g/l and Al/Cl=1.8 (atomic ratio) to have an alumina-based fiber composition of Al₂O₃:SiO₂=72:28, thereby forming an alumina-based fiber precursor. Subsequently, an organic polymer such as polyvinyl alcohol is added and after concentrating the resulting solution to prepare a spinning solution, spinning is performed by a blowing method using the spinning solution. The spun fibers are folded in a stacked state to form an alumina-based fiber sheet member. This sheet member is subjected to a needling treatment by using a needle board having 80 needles/100 cm² to obtain a desired needle density, thereby producing a needle-punched mat. The obtained sheet member is continuously fired from an ordinary temperature to a maximum temperature of 1,250° C. to form a second sheet member formed of an alumina-based fiber having a basis weight of 750 g/cm². At this time, the average diameter of the alumina-based fiber is 7.2 μm, and the minimum diameter is 3.2 μm. Also, the resin content after drying is set to 5% by attaching an acrylic latex emulsion as a binder.

The first sheet member 11 and the second sheet member 12 are stacked by aligning respective outflow-side edge parts and laminating together the surfaces through which the sheet members are contacted with each other, by using a pressure-sensitive adhesive double-coated tape.

As shown in FIG. 2, the holding member 10 is wound around a catalyst carrier 70 on the outer circumference side by disposing the second sheet member 12 on the front surface side and the first sheet member 11 on the back surface side. At this time, two engaging protrusion parts 13 and 15 are engaged with two engaging recess parts 14 and 16, whereby the holding member is integrally installed on the catalyst carrier 70.

The catalyst carrier 70 is obtained by forming, for example, a ceramic material having high heat resistance, as typified by cordierite, alumina, mullite, spinel and the like, into a cylindrical honeycomb and loading a well-known three-way catalyst (for example, a platinum/rhodium/palladium catalyst) thereon.

As shown in FIGS. 3 and 4, the holding sheet material 10 installed on the catalyst carrier 70 is press-fit into a housing 81 of an exhaust gas treating device 80 at a GBD of 0.5 g/cm³ or more that allows the start of fiber crush.

At this time, in the holding member 10, on the left-hand exhaust gas inflow side in FIG. 3, the end part of the second sheet member 12 protruded from the first sheet member 11 by a width dimension L4 is bent to the first sheet member 11 side, whereby a bent part 17 is formed.

In the holding member 10, the portion where the first sheet member 11 and the second sheet member 12 are stacked and overlapped in the diameter direction comes to have a GBD of 0.5 g/cm³ or more at which fiber crush starts. As a result, a surface pressure large enough to hold the catalyst carrier 70 can be imparted and at the same time, the fiber is broken to shorten the fiber length and start the reduction in the eolian erosion resistance performance.

Also, in the bent part 17 on the exhaust gas inflow side, where the first sheet member 11 and the second sheet member 12 are not stacked and not overlapped, because of one layer, the GBD becomes low and is from 0.25 to 0.55 g/cm³ and the fiber is not damaged, as a result, the eolian erosion resistance performance does not decrease.

Incidentally, for the application to a diesel engine, an exhaust gas filter obtained by forming a material having high heat resistance, such as ceramic material, into a porous cylindrical honeycomb may also be disposed on the outflow side of the catalyst carrier 70.

The first sheet member 11 may also be molded by papermaking. Furthermore, the first sheet member 11 may also be an expanded mat where vermiculite is mixed. In this case, the thickness of the first sheet member 11 can be easily adjusted.

As described in the foregoing, the holding member 10 according to the first embodiment of the present invention is press-fit into a housing 81 at a GBD of 0.5 g/cm³ or more that allows the start of fiber crush, and therefore, the portion where two sheet members 11 and 12 are stacked and overlapped in the diameter direction comes to have a GBD of 0.5 g/cm³ or more at which fiber crush starts, as a result, a surface pressure necessary for holding the catalyst carrier 70 can be ensured and at the same time, the fiber is broken to shorten the fiber length and start the reduction in the eolian erosion resistance performance. On the other hand, in the portion where two sheet members 11 and 12 are not stacked and not overlapped, because of one layer, the GBD becomes less than 0.5 g/cm³ and the fiber is not damaged, so that reduction in the eolian erosion resistance performance can be prevented. As a result, the concern about eolian erosion in holding an exhaust gas treating element having a large weight can be eliminated, high design freedom is enabled, and the exhaust gas treating property can be enhanced.

Also, according to the holding member 10, the bent part 17 of the second sheet member 12 having a larger width dimension, which is protruded from the first sheet member 11 having a smaller width dimension, comes to have a low GBD, so that reduction in the eolian erosion resistance performance can be more inhibited.

Furthermore, according to the holding member 10, an organic binder such as acrylic latex emulsion is used as the bonding material to bind the inorganic fiber as the main component by the organic binder, so that flying of the fiber can be suppressed and the handleability by a worker can be enhanced.

In addition, according to the holding member 10, the inorganic fiber is formed by blending silica to alumina, so that heat resistance can be enhanced and at the same time, an alumina-based precursor assured of eolian erosion resistance can be produced.

Also, according to the holding member 10, the second sheet member 12 is a needle-punched mat, so that eolian erosion resistance in particular can be ensured and by virtue of increased strength, breakage at the installation can be prevented.

Furthermore, according to the holding member 10, the first sheet member 11 may be molded by papermaking, so that the thickness can be easily adjusted. Furthermore, the first sheet member 11 may be an expanded mat in which vermiculite is mixed, so that the surface pressure can be easily controlled.

In the exhaust gas treating device 80 according to the first embodiment of the present invention, the portion where two sheet members 11 and 12 are stacked and overlapped in the diameter direction comes to have a GBD not less than that at which fiber crush starts, as a result, a surface pressure necessary for holding the catalyst carrier 70 can be ensured and at the same time, the fiber is broken to shorten the fiber length and start the reduction in the eolian erosion resistance performance. On the other hand, in the portion where two sheet members 11 and 12 are not stacked and not overlapped, because of one layer, the GBD becomes low and the fiber is not damaged, so that reduction in the eolian erosion resistance performance can be prevented. As a result, the concern about eolian erosion in holding an exhaust gas treating element having a large weight can be eliminated, the holding member 10 can be installed at a high developed surface pressure, thereby increasing the design freedom, for example, enabling the catalyst carrier 70 to have a large diameter and a small length, and at the same time, by ensuring the eolian erosion resistance performance, the exhaust gas treating property can be enhanced.

Also, according to the exhaust gas treating device 80, the holding member 10 can be applied to a catalyst carrier 70 obtained by forming a ceramic material having high heat resistance, as typified by cordierite, alumina, mullite, spinel and the like, into a cylindrical honeycomb and loading a well-known three-way catalyst (for example, a platinum/rhodium/palladium catalyst) thereon. The holding member 10 can also be applied to an exhaust gas filter obtained by forming a material having high heat resistance, such as ceramic material, into a porous cylindrical honeycomb. In this way, the holding member can be used as a holding member 10 having high general-purpose applicability to both a gasoline engine and a diesel engine.

### Second Embodiment

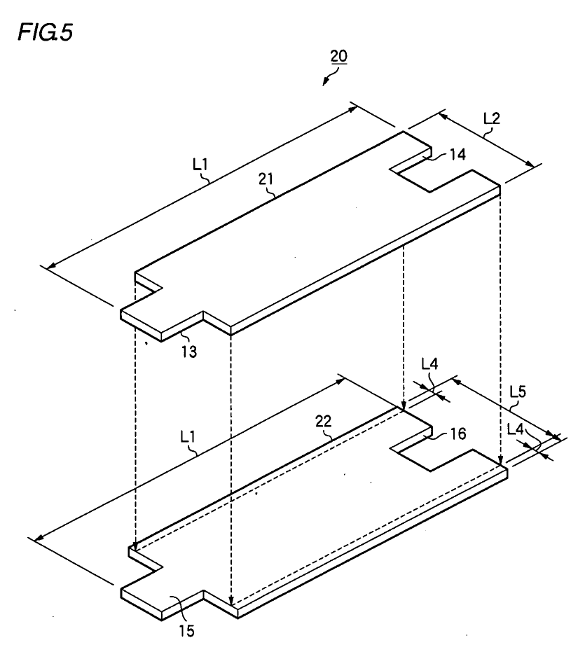

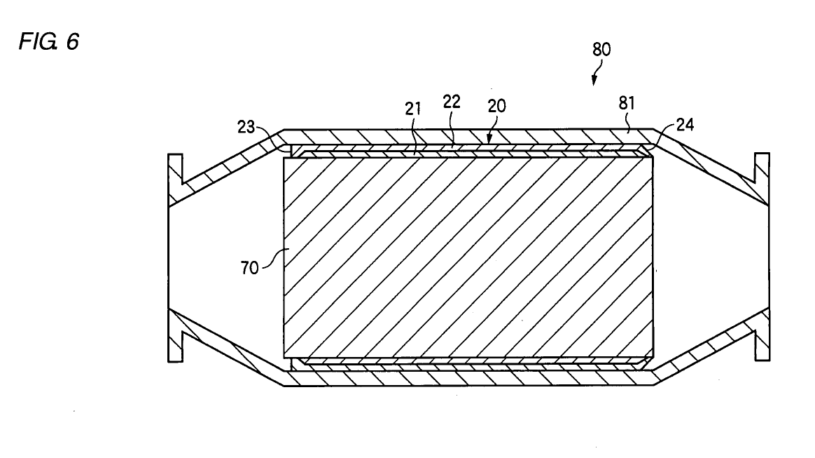

The second embodiment of the present invention is described below by referring to FIGS. 5 and 6.

FIGS. 5 and 6 show the holding member and exhaust gas treating device according to the second embodiment of the present invention. FIG. 5 is an exploded perspective view of the holding member according to the second embodiment of the present invention, and FIG. 6 is a longitudinal cross-sectional view of the exhaust gas treating device according to the second embodiment of the present invention. In each of the following embodiments, constituent portions in common with the first embodiment are indicated by identical or corresponding numerical references and description thereof is simplified or omitted.

As shown in FIG. 5, the holding member 20 according to the second embodiment of the present invention is obtained by stacking a first sheet member (layer A) 21 and a second sheet member (layer B) 22. The first sheet member 21 is formed, for example, by punching into a length dimension L1 of 440 mm and a width dimension L2 of 110 mm, and the second sheet member 22 is formed, for example, by punching into a length dimension L1 of 440 mm and a width dimension L5 of 130 mm to be larger on both sides than the first sheet member 21 by a specific width dimension L4 of 10 mm. Other sites are constructed in the same manner as in the first embodiment.

As shown in FIG. 6, the holding member 20 installed on a catalyst carrier 70 is press-fit into a housing 81 of an exhaust gas treating device 80 at a GBD of 0.5 g/cm³ or more that allows the start of fiber crush.

At this time, in the holding member 20, on the left-hand exhaust gas inflow side in FIG. 6, one end part of the second sheet member 22 protruded from the first sheet member 21 by a width dimension L4 is bent to the first sheet member 21 side, whereby a bent part 23 is formed. Also, on the right-hand exhaust gas outflow side in FIG. 6, another end part of the second sheet member 22 protruded from the first sheet member 21 by a width dimension L4 is bent to the first sheet member 21 side, whereby a bent part 24 is formed.

In the holding member 20, the portion where the first sheet member 21 and the second sheet member 22 are stacked and overlapped in the diameter direction comes to have a GBD of 0.5 g/cm³ or more at which fiber crush starts. As a result, a surface pressure large enough to hold the catalyst carrier 70 can be imparted and at the same time, the fiber is broken to shorten the fiber length and start the reduction in the eolian erosion resistance performance.

Also, in the bent parts 23 and 24 on the exhaust gas inflow and outflow sides, where the first sheet member 21 and the second sheet member 22 are not stacked and not overlapped, because of one layer, the GBD becomes low and is from 0.25 to 0.55 g/cm³ and the fiber is not damaged, as a result, the eolian erosion resistance performance does not decrease. Incidentally, if the GBD is less than 0.25 g/cm³, the fiber is broken and flies apart resulting from easy movement due to low surface pressure. Also, if the GBD exceeds 0.55 g/cm³, the fiber becomes short resulting from breakage due to the surface pressure and flies apart.

The holding member 20 according to the second embodiment produces the same operations and effects as in the first embodiment. In particular, according to this embodiment, the GBD becomes low by virtue of bent parts 23 and 24 on the exhaust gas inflow and outflow sides, so that reduction in the eolian erosion resistance performance can be more inhibited.

### Third Embodiment

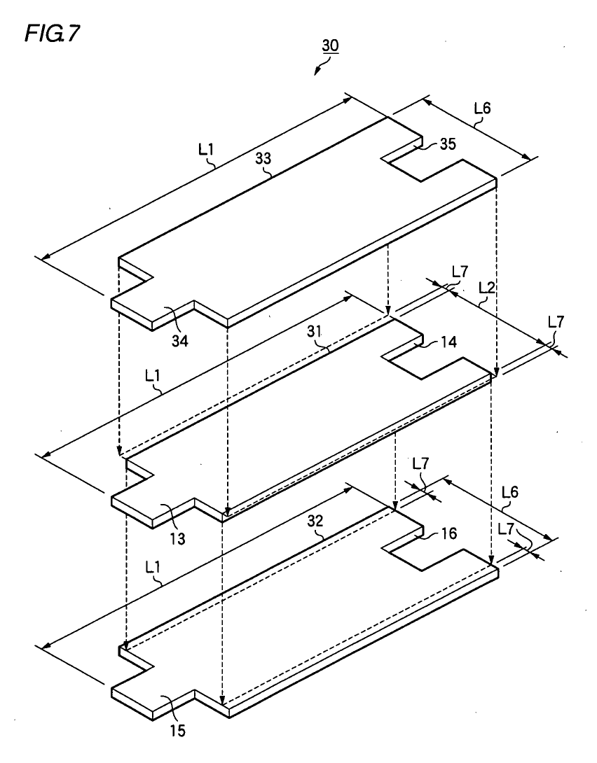

The third embodiment of the present invention is described below by referring to FIGS. 7 to 9.

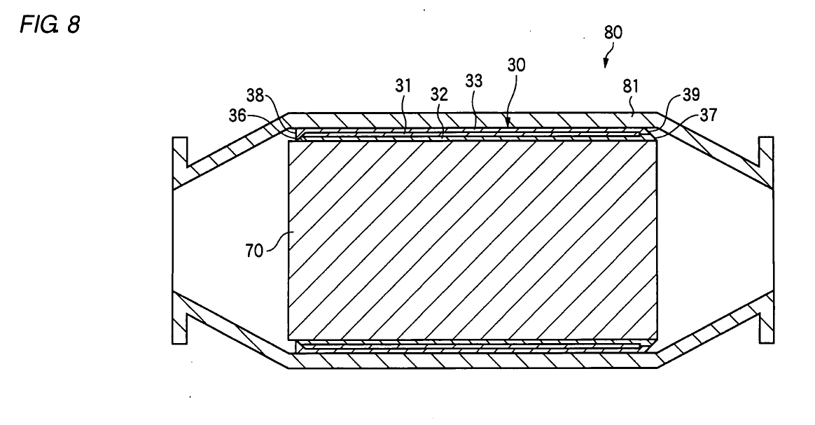

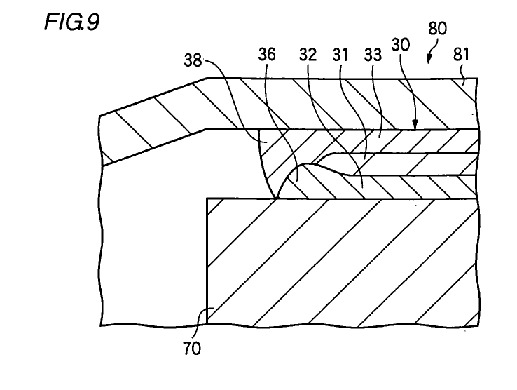

FIGS. 7 to 9 show the holding member and exhaust gas treating device according to the third embodiment of the present invention. FIG. 7 is an exploded perspective view of the holding member according to the third embodiment of the present invention, FIG. 8 is a longitudinal cross-sectional view of the exhaust gas treating device according to the third embodiment of the present invention, and FIG. 9 is an enlarged view showing main parts of the exhaust gas treating device of FIG. 8.

As shown in FIG. 7, the holding member 30 according to the third embodiment of the present invention is obtained by stacking a first sheet member (layer A) 31, a second sheet member (layer B) 32 and a third sheet member 33 (layer C) that is the same as the second sheet member 32. The first sheet member 31 is formed, for example, by punching into a length dimension L1 of 440 mm and a width dimension L2 of 110 mm, and the second sheet member 32 is formed, for example, by punching into a length dimension L1 of 440 mm and a width dimension L6 of 120 mm to be larger on both sides than the first sheet member 31 by a specific width dimension L7 of 5 mm.

In addition, the third sheet member 33 is formed in the same manner as the second sheet member 32, for example, by punching into a length dimension L1 of 440 mm and a width dimension L6 of 120 mm to be larger on both sides than the first sheet member 11 by a specific width dimension L7 of 5 mm, and an engaging protrusion part 34 and an engaging recess part 35 are formed. Other sites are constructed in the same manner as in the first embodiment.

As shown in FIGS. 8 and 9, the holding member 30 installed on a catalyst carrier 70 is press-fit into a housing 81 of an exhaust gas treating device 80 at a GBD of 0.5 g/cm³ or more that allows the start of fiber crush.

At this time, in the holding member 30, on the left-hand exhaust gas inflow side in FIG. 8, one end part of the second sheet member 32 protruded from the first sheet member 31 by a width dimension L7 is bent to the first sheet member 31 side, whereby a bent part 36 is formed. Also, on the right-hand exhaust gas outflow side in FIG. 8, another end part of the second sheet member 32 protruded from the first sheet member 31 by a width dimension L7 is bent to the first sheet member 31 side, whereby a bent part 37 is formed.

In addition, in the holding member 30, on the exhaust gas inflow side, one end part of the third sheet member 33 protruded from the first sheet member 31 by a width dimension L7 is bent to the first sheet member 31 side, whereby a bent part 38 is formed. Also, on the exhaust gas outflow side, another end part of the third sheet member 33 protruded from the first sheet member 31 by a width dimension L7 is bent to the first sheet member 31 side, whereby a bent part 39 is formed.

In the holding member 30, the portion where the first sheet member 31, the second sheet member 32 and the third sheet member 33 are stacked and overlapped in the diameter direction comes to have a GBD of 0.5 g/cm³ or more at which fiber crush starts. As a result, a surface pressure large enough to hold the catalyst carrier 70 can be imparted and at the same time, the fiber is broken to shorten the fiber length and start the reduction in the eolian erosion resistance performance.

Also, the bent parts 36, 37, 38 and 39 on the exhaust gas inflow and outflow sides each is composed of two layers, where the first sheet member 31, the second sheet member 32 and the third sheet member 33 are not stacked and not overlapped, and comes to have a low GBD of 0.25 to 0.55 g/cm³, as a result, the fiber is not damaged and the eolian erosion resistance performance does not decrease.

The holding member 30 according to the third embodiment produces the same operations and effects as in the first embodiment. In particular, according to this embodiment, the bent parts 36, 37, 38 and 39 on the exhaust gas inflow and outflow sides are smaller in the width dimension than in the second embodiment and the bent end part thereby forms a flush surface at the press fitting into a housing 81, so that not only the installation can be facilitated but also the length of the catalyst carrier 70 can be effectively utilized. Also, the second sheet member 32 and the third sheet member 33 each is reduced in the deformation volume after installation and therefore, reduction in the eolian erosion resistance performance can be more inhibited. In addition, by virtue of enhancement in the holding power in the center portion and enhancement in the eolian erosion resistance in the end part portion, the design of GBD in the center portion and end part portion becomes easy.

### Fourth Embodiment

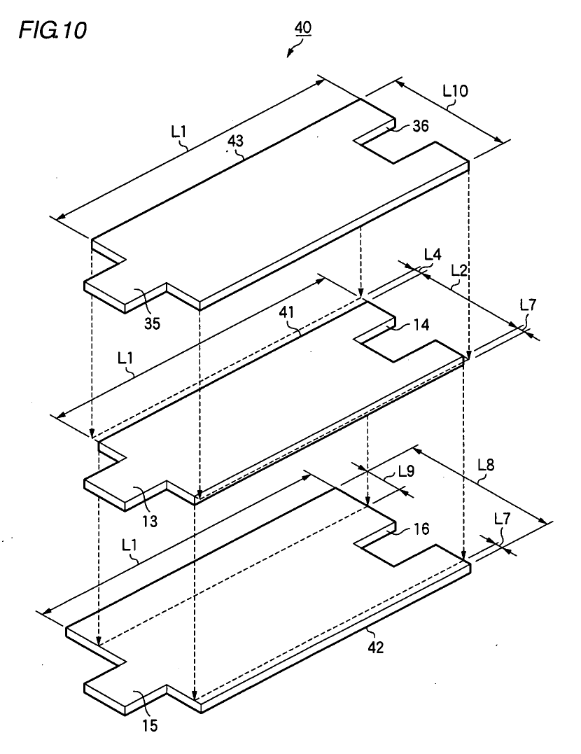

The fourth embodiment of the present invention is described below by referring to FIGS. 10 to 12.

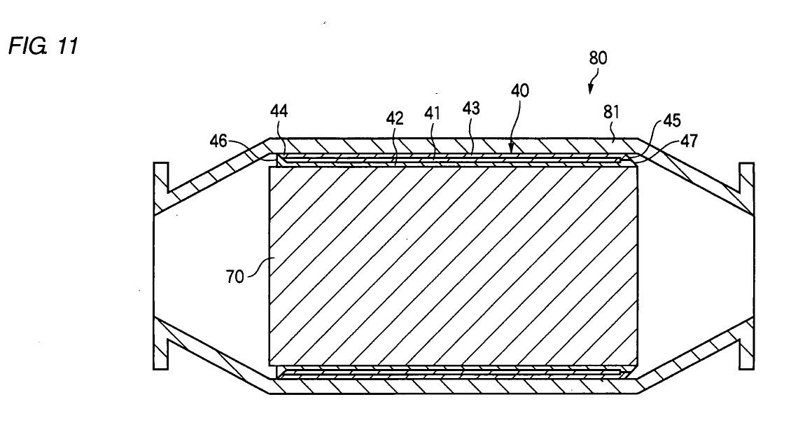

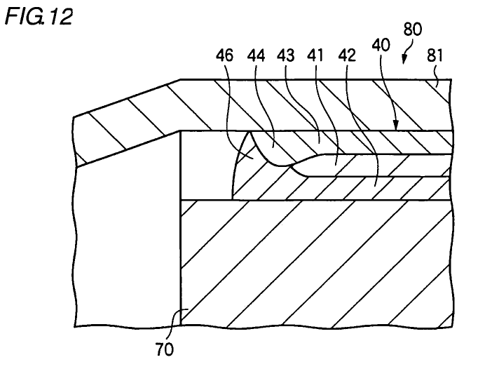

FIGS. 10 to 12 show the holding member and exhaust gas treating device according to the fourth embodiment of the present invention. FIG. 10 is an exploded perspective view of the holding member according to the fourth embodiment of the present invention, FIG. 11 is a longitudinal cross-sectional view of the exhaust gas treating device according to the fourth embodiment of the present invention, and FIG. 12 is an enlarged view showing main parts of the exhaust gas treating device of FIG. 11.

As shown in FIG. 10, the holding member 40 according to the fourth embodiment of the present invention is obtained by stacking a first sheet member (layer A) 41, a second sheet member (layer B) 42 and a third sheet member 43 (layer C). The first sheet member 41 is formed, for example, by punching into a length dimension L1 of 440 mm and a width dimension L2 of 110 mm, and the second sheet member 42 is formed, for example, by punching into a length dimension L1 of 440 mm and a width dimension L8 of 140 mm to be larger on the inflow side than the first sheet member 41 by a specific width dimension L9 of 25 mm and larger on the outflow side than the first sheet member 41 by a specific width dimension L7 of 5 mm.

In addition, the third sheet member 43 is formed, for example, by punching into a length dimension L1 of 440 mm and a width dimension L10 of 125 mm to be larger on the inflow side than the first sheet member 41 by a specific width dimension L4 of 10 mm and larger on the outflow side than the first sheet member 41 by a specific width dimension L7 of 5 mm. Other sites are constructed in the same manner as in the first embodiment.

As shown in FIGS. 11 and 12, the holding member 40 installed on a catalyst carrier 70 is press-fit into a housing 81 of an exhaust gas treating device 80 at a GBD of 0.5 g/cm³ or more that allows the start of fiber crush.

At this time, in the holding member 40, on the left-hand exhaust gas inflow side in FIG. 11, one end part of the third sheet member 43 protruded from the first sheet member 41 by a width dimension L4 is bent to the first sheet member 41 side, whereby a bent part 44 is formed. Also, on the right-hand exhaust gas outflow side in FIG. 11, another end part of the third sheet member 43 protruded from the first sheet member 41 by a width dimension L7 is bent to the first sheet member 41 side, whereby a bent part 45 is formed.

In addition, in the holding member 40, on the exhaust gas inflow side, one end part of the second sheet member 42 protruded from the first sheet member 41 by a width dimension L9 is bent to the first sheet member 41 and second sheet member 42 sides, whereby a bent part 46 is formed. Also, on the exhaust gas outflow side, another end part of the second sheet member 42 protruded from the first sheet member 41 by a width dimension L7 is bent to the first sheet member 41 side, whereby a bent part 47 is formed.

In the holding member 40, the portion where the first sheet member 41, the second sheet member 42 and the third sheet member 43 are stacked and overlapped in the diameter direction comes to have a GBD of 0.5 g/cm³ or more at which fiber crush starts. As a result, a surface pressure large enough to hold the catalyst carrier 70 can be imparted and at the same time, the fiber is broken to shorten the fiber length and start the reduction in the eolian erosion resistance performance.

Also, in the bent parts 44, 45, 46 and 47 on the exhaust gas inflow and outflow sides, where the first sheet member 41, the second sheet member 42 and the third sheet member 43 are not stacked and not overlapped, because of one layer or two layers, the GBD becomes low and is from 0.25 to 0.55 g/cm³, preferably from 0.3 to 0.5 g/cm³, and the fiber is not damaged, as a result, the eolian erosion resistance performance does not decrease. Incidentally, if the GBD is less than 0.25 g/cm³, the fiber is broken and flies apart resulting from movement due to low surface pressure. Also, if the GBD exceeds 0.55 g/cm³, the fiber becomes short resulting from breakage due to the surface pressure and flies apart.

The holding member 40 according to the fourth embodiment produces the same operations and effects as in the first embodiment. In particular, according to this embodiment, the shear strain generated at the installation by press fitting can be corrected.

### Fifth Embodiment

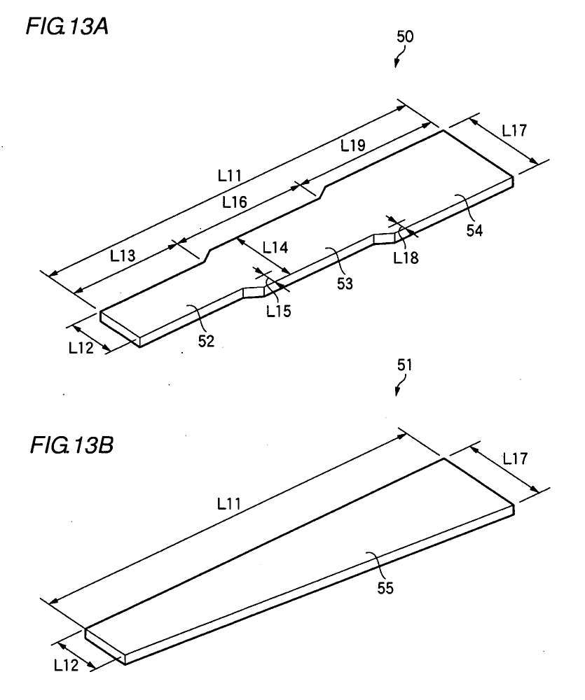

The fifth embodiment of the present invention is described below by referring to FIGS. 13A to 15.

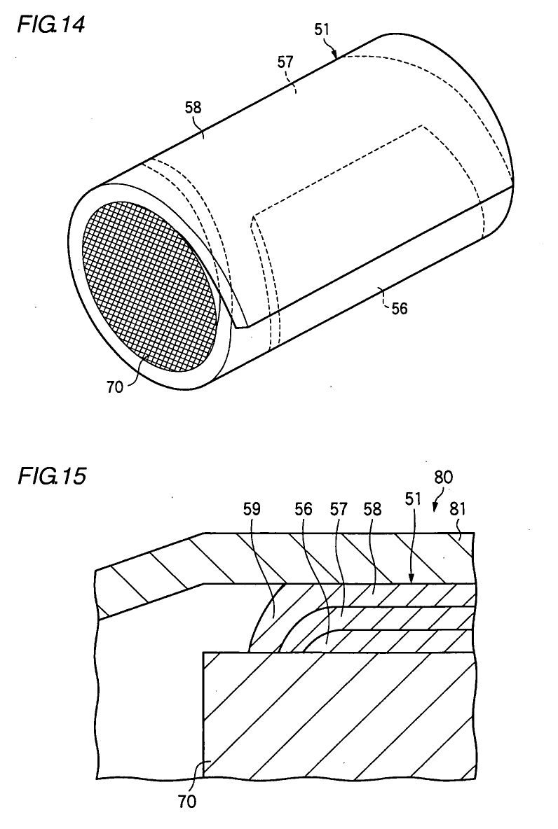

FIGS. 13A to 15 show the holding member and exhaust gas treating device according to the fifth embodiment of the present invention. FIG. 13A is a perspective view of the holding member according to the fifth embodiment of the present invention, FIG. 13B is a perspective view of another holding member according to the fifth embodiment of the present invention, FIG. 14 is an appearance perspective view where the holding member of FIG. 13B is installed on a catalyst carrier, and FIG. 15 is an enlarged view showing main parts of the exhaust gas treating device of FIG. 14.

As shown in FIGS. 13A and 13B, unlike the holding members 10, 20, 30 and 40 of the first to fourth embodiments, the holding members 50 and 51 according to the fifth embodiment of the present invention each is one single-layer sheet and is a winding type of winding a plurality of turns of the sheet around the outer periphery of a catalyst carrier 70. The holding members 50 and 51 of this embodiment are a three-turn winding type and may take a form of winding two turns or four or more turns.

As for the first sheet members 50 and 51, a silica sol is blended with an aqueous basic aluminum chloride solution having an aluminum content of 70 g/l and Al/Cl=1.8 (atomic ratio) to have an alumina-based fiber composition of Al₂O₃:SiO₂=72:28, thereby forming an alumina-based fiber precursor. Subsequently, an organic polymer such as polyvinyl alcohol is added and after concentrating the resulting solution to prepare a spinning solution, spinning is performed by a blowing method using the spinning solution. The spun fibers are folded in a stacked state to form an alumina-based fiber sheet member. This sheet member is subjected to a needling treatment by using a needle board having 80 needles/100 cm² to obtain a desired needle density, thereby producing a needle-punched mat. The obtained sheet member is continuously fired from an ordinary temperature to a maximum temperature of 1,250° C. to form a sheet member formed of an alumina-based fiber having a basis weight of 750 g/cm². At this time, the average diameter of the alumina-based fiber is 7.2 μm, and the minimum diameter is 3.2 μm. Also, the resin content after drying is set to 5% by attaching an acrylic latex emulsion as a binder.

The holding member 50 shown in FIG. 13A includes a narrow-width first sheet part 52 for forming a first layer as a start of winding, a second sheet part 53 for forming an intermediate second layer, and a third sheet part 54 for forming a third layer as an end of winding. For example, the holding member is formed by punching into a stepwise widened shape where the length dimension L11 is 1,340 mm and the width dimension L12 is 110 mm and increases to a width dimension L14 of 120 mm larger than L12 by a fixed width dimension L15 of 5 mm and further to a width dimension L17 of 130 mm larger than L14 by a fixed width dimension L18 of 5 mm.

In addition, for example, the first sheet part 52 is formed in a length dimension L13 of 460 mm, the second sheet part 53 is formed in a length dimension L16 of 440 mm, and the third sheet part 54 is formed in a length dimension L19 of 440 mm.

The holding member 50 is wound around the outer periphery of a catalyst carrier by starting with the first sheet part 52 and ending with the third sheet part 54 so as to continuously form the first to third layers, and the end part in the width direction of the third sheet part 54 forms a bent part at the installation in a housing of an exhaust gas treating device.

The holding member 51 shown in FIG. 13B is a sheet part 55 formed in a trapezoidal shape where the first layer as a start of winding to the third layer as an end of winding are linearly continued. The holding member is formed, for example, by punching into a trapezoidal shape where the length dimension L11 is 1,340 mm and the width dimension L12 is 110 mm and increases to a width dimension L17 of 130 mm larger than L12 by a fixed width dimension of 10 mm.

As shown in FIGS. 14 and 15, the holding member 51 is continuously wound around the outer periphery of a catalyst carrier 70, whereby the first layer 56, the second layer 57 and the third layer 58 are continuously formed. The holding member 51 installed on the catalyst carrier 70 is press-fit into a housing 81 of an exhaust gas treating device 80 at a GBD of 0.5 g/cm³ or more that allows the start of fiber crush.

At this time, in the holding member 51, on the left-hand exhaust gas inflow side in FIG. 15, a bent part 59 is formed in the end part in the width direction of the third layer 58 at the installation in the housing 81 of the exhaust gas treating device 80. Also, on the exhaust gas outflow side, a bent part 59 is similarly formed in the end part in the width direction of the third layer 58.

In the holding member 51, the portion where the sheet part 55 is stacked by three-turn winding and overlapped in the diameter direction comes to have a GBD of 0.5 g/cm³ or more that allows the start of fiber crush. As a result, a surface pressure large enough to hold the catalyst carrier 70 can be imparted and at the same time, the fiber is broken to shorten the fiber length and start the reduction in the eolian erosion resistance performance.

Also, in the bent part 59 on the exhaust gas inflow and outflow sides, where the sheet part 55 is not stacked and not overlapped, because of one layer or two layers, the GBD becomes low and is from 0.25 to 0.55 g/cm³, preferably from 0.3 to 0.5 g/cm³, and the fiber is not damaged, as a result, the eolian erosion resistance performance does not decrease.

The holding members 50 and 51 according to the fifth embodiment produce the same operations and effects as in the first embodiment. In particular, according to this embodiment, processability in forming the holding member is excellent. A single-layer holding member is wound around an exhaust gas treating element and press-fit into a housing, for example, at a GBD of 0.5 g/cm³ or more that allows the start of fiber crush, and the center portion having a three-layer structure along the axial direction of the exhaust gas treating element comes to have a GBD of 0.5 g/cm³ or more, so that a surface pressure necessary for holding the exhaust gas treating element can be ensured. Also, in the end part portion having a substantially one-layer structure, the GBD becomes low and the fiber is not damaged, so that the eolian erosion resistance performance can be ensured. As a result, the concern about eolian erosion in holding an exhaust gas treating element having a large weight can be eliminated and high design freedom is enabled. Incidentally, winding of the holding member 50 or 51 may be started from the wider side.

### Sixth Embodiment

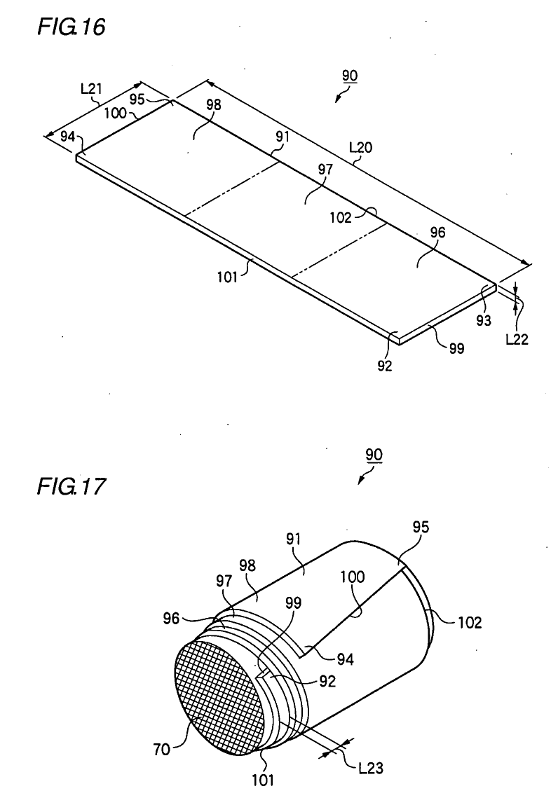

The sixth embodiment of the present invention is described below by referring to FIGS. 16 to 21.

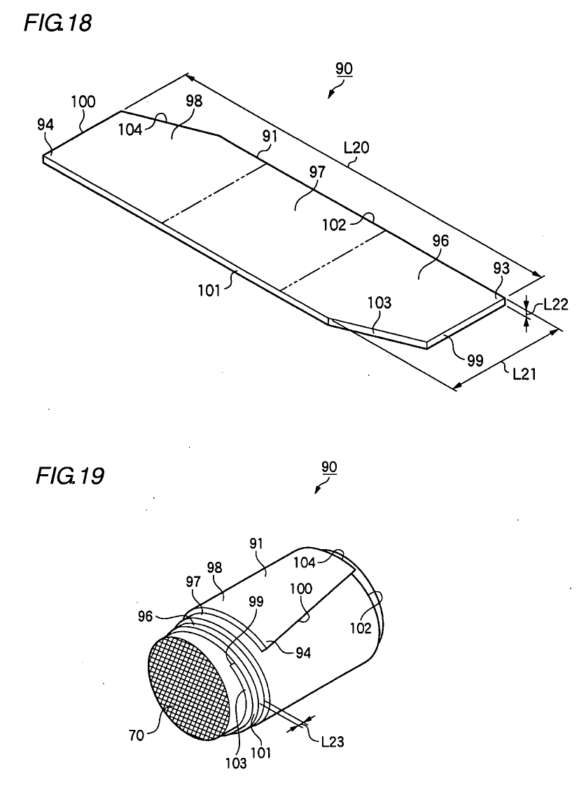

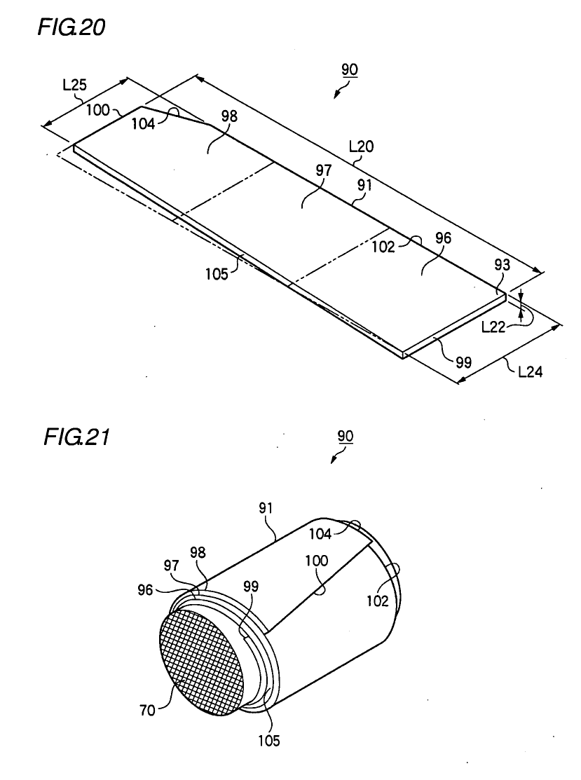

FIGS. 16 to 21 show the holding member and exhaust gas treating device according to the sixth embodiment of the present invention. FIG. 16 is a perspective view of the holding member according to the sixth embodiment of the present invention, FIG. 17 is an appearance perspective view where the holding member of FIG. 16 is installed on a catalyst carrier, FIG. 18 is a perspective view of a first modification example of the holding member according to the sixth embodiment of the present invention, FIG. 19 is an appearance perspective view where the holding member of FIG. 18 is installed on a catalyst carrier, FIG. 20 is a perspective view of a second modification example of the holding member according to the sixth embodiment of the present invention, and FIG. 21 is an appearance perspective view where the holding member of FIG. 20 is installed on a catalyst carrier.

As shown in FIG. 16, the holding member 90 according to the sixth embodiment of the present invention comprises one single-layer sheet member 91 similarly to the fifth embodiment above and is a winding type of winding a plurality of turns of the sheet member around the outer periphery of a catalyst carrier 70. The holding member 90 of this embodiment is a three-turn winding type and may take a form of winding two turns or four or more turns.

The sheet member 91 is formed, for example, in a rectangle shape where the length dimension L20 is 1,340 mm, the uniform width dimension L21 is 110 mm and the thickness dimension L22 is 6.0 mm, and has a pair of right-angled corners 92 and 93 on the winding start side and a pair of right-angled corners 94 and 95 on the opposite winding end side.

In the sheet member 91, a first sheet part 96 for forming a first layer as a start of winding, a second sheet part 97 for forming an intermediate second layer, and a third sheet part 98 for forming a third layer as an end of winding are continuously formed.

Also, the sheet member 91 has a winding start-side end face 99 between the pair of corners 92 and 93 on the winding start side and a winding end-side end face 100 between the pair of corners 94 and 95 on the opposite winding end side.

Furthermore, the sheet member 91 has an exhaust gas outflow-side end face 101 between the corner 92 on the winding start side and the corner 94 on the winding end side and has an exhaust gas inflow-side end face 102 between the corner 93 on the winding start side and the corner 95 on the winding end side.

As for the sheet member 91, for example, a silica sol is blended with an aqueous basic aluminum chloride solution having an aluminum content of 70 g/l and Al/Cl=1.8 (atomic ratio) to have an alumina-based fiber composition of Al₂O₃:SiO₂=72:28, thereby forming an alumina-based fiber precursor. Subsequently, an organic polymer such as polyvinyl alcohol is added and after concentrating the resulting solution to prepare a spinning solution, spinning is performed by a blowing method using the spinning solution. The spun fibers are folded in a stacked state to form an alumina-based fiber sheet member. This sheet member is subjected to a needling treatment by using a needle board having 80 needles/100 cm² to obtain a desired needle density, thereby producing a needle-punched mat. The obtained sheet member is continuously fired from an ordinary temperature to a maximum temperature of 1,250° C. to form a sheet member formed of an alumina-based fiber having a basis weight of 750 g/cm². At this time, the average diameter of the alumina-based fiber is 7.2 μm, and the minimum diameter is 3.2 μm. Also, the resin content after drying is set to 5% by attaching an acrylic latex emulsion as a binder.

As shown in FIG. 17, the sheet member 91 is spirally wound around a catalyst carrier 70 by aligning the corners 92 and 93 on the winding start side with one end part of the catalyst carrier 70 while displacing the sheet member to form a specific displacement dimension L23, for example, 3 mm or more, in the axial direction of the catalyst carrier 70. As a result, a holding member 90 having a three-layer structure composed of a first layer 96, a second layer 97 and a third layer 98 is formed.

The holding member 90 installed on the catalyst carrier 70 is then press-fit into a housing 81 of an exhaust gas treating device 80 at a GBD of 0.5 g/cm³ or more that allows the start of fiber crush (see, FIG. 15). By this press fitting, the second layer 97 and the third layer 98 are relatively displaced with respect to the first layer 96. As a result, in the holding member 90, the end part in the width direction of the third layer 98 is bent on the exhaust gas inflow side at the right-hand back in FIG. 17.

In the holding member 90, the portion where the sheet member 91 stacked by three-turn winding and overlapped in the diameter direction comes to have a GBD of 0.5 g/cm³ or more that allows the start of fiber crush. As a result, a surface pressure large enough to hold the catalyst carrier 70 can be imparted and at the same time, the fiber is broken to shorten the fiber length and start the reduction in the eolian erosion resistance performance.

Also, in the exhaust gas inflow and outflow sides where the sheet member 91 is not stacked and not overlapped, because of one layer or two layers, the GBD becomes low and is from 0.25 to 0.55 g/cm³, preferably from 0.3 to 0.5 g/cm³, and the fiber is not damaged, as a result, the eolian erosion resistance performance does not decrease.

As shown in FIG. 18, according to the first modification example of the holding member 90, in the sheet member 91, an outflow-side notch 103 formed by cutting the corner 92 portion is provided between the winding start-side end face 99 and the outflow-side end face 101, and on the opposite side to the outflow-side notch 103, an inflow-side notch 104 formed by cutting the corner 95 portion is provided between the winding end-side end face 100 and the inflow-side end face 102.

As shown in FIG. 19, the sheet member 91 is spirally wound around a catalyst carrier 70 by aligning the outflow-side notch 103 with one end face of the catalyst carrier 70 while displacing the sheet member to form a specific displacement dimension L23, for example, 3 mm or more, in the axial direction of the catalyst carrier 70. As a result, the second layer 97 and the outflow-side notch 103 form a uniform face at the outflow-side end face 101 and the second layer 97 and the inflow-side notch 104 form a uniform face at the inflow-side end face 102. That is, an edge of the second layer 97 and an edge of the outflow-side notch 103 is arranged in a same face, and an edge of the second layer 97 and an edge of the inflow-side notch 104 is arranged in a same face.

As shown in FIG. 20, according to the second modification example of the holding member 90, in the sheet member 91, an outflow-side notch 103 and a sloping notch face 105 formed by obliquely cutting the corner 94 are provided between the winding start-side end face 99 and the winding end-side end face 100. As a result, because of the sloping notch face 105, the sheet member 91 has a winding start-side end face 99 with a width dimension L24 and a winding end-side end face 100 with a width dimension L25 shorter than the width dimension L24.

As shown in FIG. 21, the sheet member 91 is wound around a catalyst carrier 70 by aligning the winding start-side end face 99 with one end face in the axial direction of the catalyst carrier 70. As a result, on the exhaust gas outflow side, the first layer 96, the second layer 97 and the third layer 98 form a uniform face by virtue of the sloping notch face 105. That is, edges of the first layer 96 the second layer 97 and the third layer 98 are arranged in a same face.

The holding member 90 according to the sixth embodiment produces the same operations and effects as in the first embodiment. In particular, according to this embodiment, a sheet member 91 is spirally wound around a catalyst carrier 70 while displacing the sheet member to form a specific displacement dimension L23 in the axial direction of the catalyst carrier 70 and then press-fit into a housing 81 at a GBD of 0.5 g/cm³ or more that allows the start of fiber crush. The center portion having a multilayer structure along the axial direction of the catalyst carrier 70 comes to have a GBD of 0.5 g/cm³ or more, but a surface pressure necessary for holding the catalyst carrier 70 can be ensured.

Also, the sheet member 91 is formed in a rectangle shape, so that the production can be easy and the productivity can be enhanced. Furthermore, the sheet member 91 when spirally wound around a catalyst carrier 70 while displacing the sheet member to form a specific displacement dimension L23 in the axial direction of the catalyst carrier 70 creates a uniform face without allowing protrusion of the end part by virtue of the notches 103 and 104 and the notch face 105.

In the exhaust gas treating device 80 according to the sixth embodiment, the sheet member 91 of the holding member 90 is spirally wound around a catalyst carrier 70 while displacing the sheet member to form a specific displacement dimension L23 in the axial direction of the catalyst carrier 70 and then press-fit into a housing at a GBD of 0.5 g/cm³ or more that allows the start of fiber crush. The center portion having a multilayer structure along the axial direction of the catalyst carrier 70 has a GBD of 0.5 g/cm³ or more at which fiber crush starts, but a surface pressure necessary for holding the catalyst carrier 70 can be ensured.

Furthermore, in the end part portion where the displacement dimension L23 is set, the GBD becomes low and the fiber is not damaged, so that an eolian erosion resistance performance can be ensured. As a result, the concern about eolian erosion in holding an exhaust gas treating element having a large weight can be eliminated, high design freedom is enabled, and the exhaust gas treating property can be enhanced.

### Seventh Embodiment

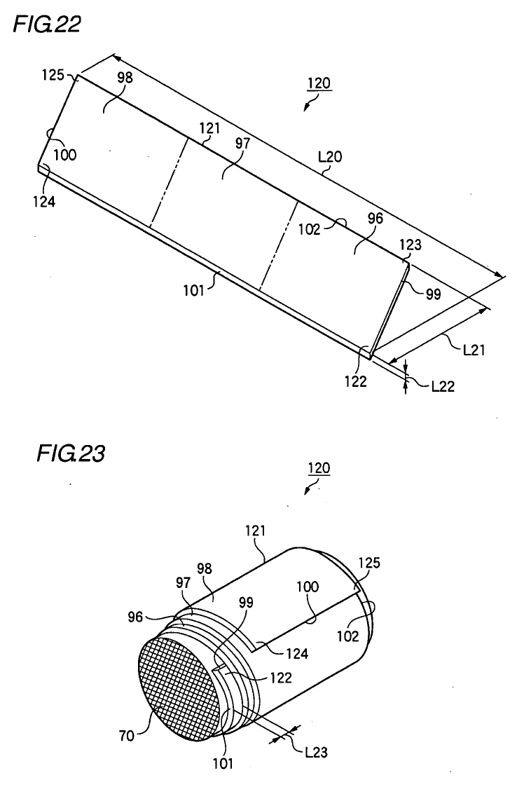

The seventh embodiment of the present invention is described below by referring to FIGS. 22 to 27.

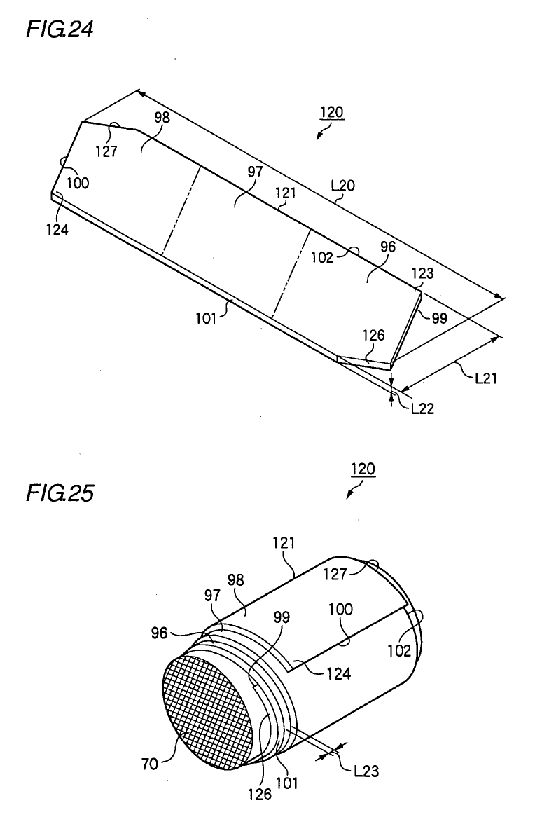

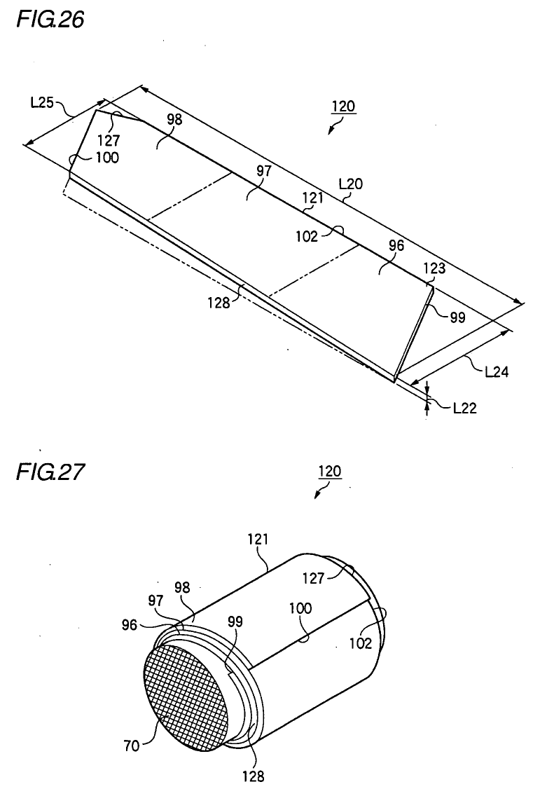

FIGS. 22 to 27 show the holding member and exhaust gas treating device according to the seventh embodiment of the present invention. FIG. 22 is a perspective view of the holding member according to the seventh embodiment of the present invention, FIG. 23 is an appearance perspective view where the holding member of FIG. 22 is installed on a catalyst carrier, FIG. 24 is a perspective view of a first modification example of the holding member according to the seventh embodiment of the present invention, FIG. 25 is an appearance perspective view where the holding member of FIG. 24 is installed on a catalyst carrier, FIG. 26 is a perspective view of a second modification example of the holding member according to the seventh embodiment of the present invention, and FIG. 27 is an appearance perspective view where the holding member of FIG. 26 is installed on a catalyst carrier.

As shown in FIG. 22, the holding member 120 according to the seventh embodiment of the present invention comprises one single-layer sheet member 121 similarly to the sixth embodiment above and is a winding type of winding a plurality of turns of the sheet member around the outer periphery of a catalyst carrier 70. The holding member 120 of this embodiment is a three-turn winding type and may take a form of winding two turns or four or more turns.

The sheet member 121 is formed, for example, in a parallelogram shape where the length dimension L20 is 1,340 mm, the uniform width dimension L21 is 110 mm and the thickness dimension L22 is 6.0 mm, and has an acute-angled corner 122 and an obtuse-angled corner 123 on the winding start side and an obtuse-angled corner 124 and an acute-angled corner 125 on the opposite winding end side.

As shown in FIG. 23, the sheet member 121 is spirally wound around a catalyst carrier 70 by aligning the acute-angled corner 122 and the obtuse-angled corner 123 on the winding start side with one end part of the catalyst carrier 70 while displacing the sheet member to form a specific displacement dimension L23, for example, 3 mm or more, in the axial direction of the catalyst carrier 70. As a result, a holding member 120 having a three-layer structure composed of a first layer 96, a second layer 97 and a third layer 98 is formed.

The holding member 120 installed on the catalyst carrier 70 is then press-fit into a housing 81 of an exhaust gas treating device 80 at a GBD of 0.5 g/cm³ or more that allows the start of fiber crush. By this press fitting, the second layer 97 and the third layer 98 are relatively displaced with respect to the first layer 96, and the outflow-side end face 101 of the holding member 120 forms a uniform face.

As shown in FIG. 24, according to the first modification example of the holding member 120, in the sheet member 121, an outflow-side notch 126 formed by cutting the acute-angled corner 122 portion is provided between the winding start-side end face 99 and the outflow-side end face 101, and on the opposite side to the outflow-side notch 126, an inflow-side notch 127 formed by cutting the acute-angled corner 125 portion is provided between the winding end-side end face 100 and the inflow-side end face 102.

As shown in FIG. 25, the sheet member 121 is spirally wound around a catalyst carrier 70 by aligning the outflow-side notch 126 with one end face of the catalyst carrier 70 while displacing the sheet member to form a specific displacement dimension L23, for example, 3 mm or more, in the axial direction of the catalyst carrier 70. As a result, the second layer 97 and the outflow-side notch 126 form a uniform face at the outflow-side end face 101 and the second layer 97 and the inflow-side notch 127 form a uniform face at the outflow-side end face 102.

As shown in FIG. 26, according to the second modification example of the holding member 120, in the sheet member 121, an outflow-side notch 126 and a sloping notch face 128 formed by obliquely cutting the corner 124 are provided between the winding start-side end face 99 and the winding end-side end face 100.

As shown in FIG. 27, the sheet member 121 is spirally wound around a catalyst carrier 70 by aligning the winding start-side end face 99 with one end face of the catalyst carrier 70 while displacing the sheet member to form a specific displacement dimension L23, for example, 3 mm or more, in the axial direction of the catalyst carrier 70. As a result, the first layer 96, the second layer 97 and the third layer 98 form a uniform face at the outflow-side end face 101.

The holding member 120 according to the seventh embodiment produces the same operations and effects as in the first embodiment. In particular, according to this embodiment, by virtue of forming the sheet member 121 in a parallelogram shape, the inflow-side end face 99 and the outflow-side end face 100 can be disposed in parallel in the axial direction of the catalyst carrier 70, so that the position of the sheet member 121 with respect to the catalyst carrier 70 can be stabilized.

Incidentally, the holding member and exhaust gas treating device of the present invention are not limited to the embodiments described above, and modifications, improvements and the like can be appropriately made therein.

For example, the extruded portion of each seal member may be applied by replacing the inflow side and the outflow side with each other.

Also, in the first to fourth embodiments, the second sheet member may be displaced with respect to the first sheet member by using the shear force at the press fitting, or cutting may be performed so that the end face on the exhaust gas outflow side can form a uniform face.

### EXAMPLES

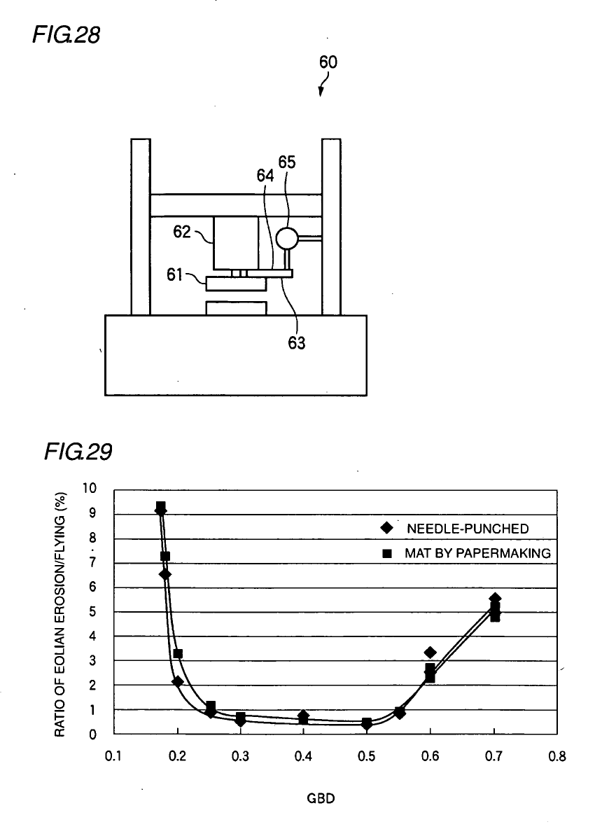

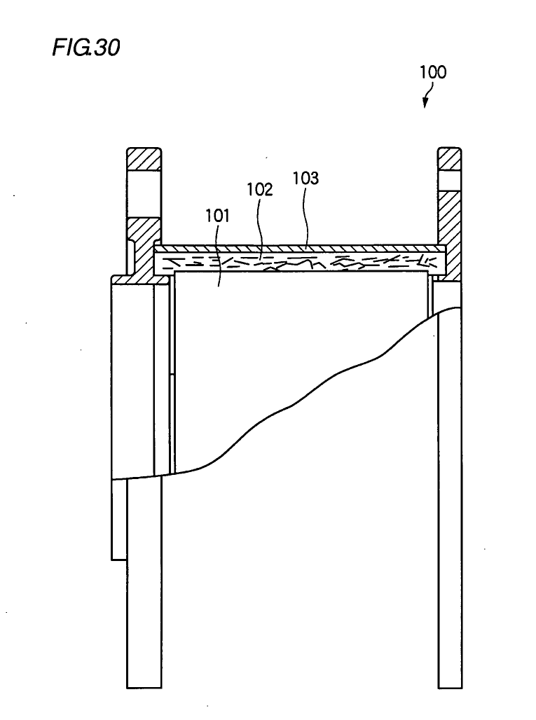

Examples performed to confirm the operations and effects of the holding member and exhaust gas treating device of an embodiment of the present invention by using a surface pressure measuring apparatus shown in FIG. 28 are described below. In Examples, out of the first to seventh embodiments, the holding members 10 and 20 of the first and second embodiments are selected as the representative of the holding member. FIG. 28 is a front view of the pressure surface measuring apparatus.

(Measurement of Surface Pressure and Eolian Erosion Property)

First, the measurement of the surface pressure was performed using the surface pressure measuring apparatus 60 shown in FIG. 28. The surface pressure measuring apparatus 60 is a gate-type universal material tester. A sample 64 was nipped by a fixing jig 63 disposed between a plate 61 and a measurement base 62 and measured by a displacement measuring device 65 by applying a compression load to the sample 64 from the plate 61 such that the bulk density GBD after compression became the desired condition. As for the sample 64, a sheet member formed of an alumina fiber aggregate and punched into a 25-mm square was prepared.

In the measurement of the surface pressure, a sample where the first sheet member (layer A) and the second sheet member (layer B) each is a needle-punched mat was prepared as Example 1, a sample where the first sheet member (layer A) is a mat molded by papermaking and the second sheet member (layer B) is a needle-punched mat was prepared as Example 2, and samples having one layer which is a needle-punched mat differing in the basis weight were prepared as Comparative Examples 1 and 2.

In general, the needle-punched mat is formed by needling and then firing spun fibers. Fibers are intertwined with each other and therefore, strength against shear force is high.

The mat by papermaking is formed by subjecting spun fibers to firing, grinding, addition of water and a binder, papermaking and drying. The fiber length is as short as approximately from 0.3 to 0.5 mm, and the thickness can be adjusted, though a large amount of a binder is required at the production.

Next, an eolian erosion property test was performed, and the measured values of the surface pressure and eolian erosion property are shown in Table 1. FIG. 29 shows the evaluation of the surface pressure and eolian erosion.

TABLE 1

| | | | | | | | | | | | Ratio of | |
|---|---|---|---|---|---|---|---|---|---|---|---|---|
| | | | | | | | | | | | Eolian | |
| | | | | | | | Width of | | | | Erosion/ | |
| | Production Method | | Basis Weight | | Width | | Surplus End | GBD at 4 mm | | Compression | Flying | Eolian |
| | of Mat | | Layer A | Layer B | Layer A | Layer B | Part of Layer | GAP | | Surface | at 4 mm | Erosion |
| | Layer A | Layer B | (g/m²) | (g/m²) | (mm) | (mm) | B (mm) | Layer B | A + B | Pressure | GAP (%) | Resistance |
| Example 1 | needling | needling | 1200 | 1200 | 110 | 130 | 10 | 0.3 | 0.60 | 1320 | 0.6 | Good |
| Example 2 | papermaking | needling | 1300 | 1200 | 110 | 130 | 10 | 0.3 | 0.63 | 1550 | 0.6 | Good |
| Comparative | | needling, | | 2400 | | 130 | 0 | 0.6 | | 1360 | 3.2 | Bad |
| Example 1 | | one layer | | | | | | | | | | |
| Comparative | | needling, | | 1200 | | 130 | 0 | 0.3 | | 170 | 0.6 | Good |
| Example 2 | | one layer | | | | | | | | | | |

As apparent from Table 1 and FIG. 29, in Examples 1 and 2, the end of the layer B wide in the width direction is exposed to an exhaust gas after installation in an exhaust gas treating device. In the end part of the layer B after installation, GBD is 0.3 g/cm³, revealing that the eolian erosion resistance is good. Also, in the portion where the layers A and B are overlapped in the diameter direction, GBD is 0.6 g/cm³, revealing that a large surface pressure is obtained.

The reason therefor is as follows. By virtue of press fitting into a housing at a GBD of 0.5 g/cm³ or more that allows the start of fiber crush, the portion where sheet members are stacked and overlapped in the diameter direction comes to have a GBD of 0.5 g/cm³ or more at which fiber crush starts. As a result, a surface pressure necessary for holding an exhaust gas treating element can be ensured and at the same time, the fiber is broken to shorten the fiber length and start the reduction in the eolian erosion resistance performance. Also, in the portion where sheet members are not stacked and not overlapped, because of one layer, the GBD becomes low and the fiber is not damaged, so that reduction in the eolian erosion resistance performance can be avoided.

On the other hand, in Comparative Example 1, the member is exposed to an exhaust gas after installation in an exhaust gas treating device. In the end part, GBD is 0.6 g/cm³, and eolian erosion of the fiber may occur. Also, in Comparative Example 2, similarly to Comparative Example 1, the member is exposed to an exhaust gas after installation in an exhaust gas treating device. In the end part, GBD is 0.3 g/cm³, and there is no possibility of causing eolian erosion of the fiber, but the surface pressure becomes low and a surface pressure necessary for holding a catalyst carrier having a large weight may be difficult to obtain.

As apparent from the measurement of surface pressure and eolian erosion property, in Examples 1 and 2, the eolian erosion resistance is good in the range of 0.25≦GBD≦0.55, particularly in the range of 0.3≦GBD≦0.5. In the case of a mat by papermaking, the fiber length is short and is from 0.3 to 0.5 mm, and therefore, eolian erosion rapidly proceeds with a low GBD of 0.3 g/cm³ or less. Furthermore, the eolian erosion rapidly proceeds also at a high GBD of 0.6 g/cm³ or more.

On the other hand, in the case of a needle-punched mat, fibers are intertwined with each other and therefore, eolian erosion hardly proceeds even with a low GBD of 0.3 g/cm³ or less.

In Examples above, out of the first to seventh embodiments, the holding members 10 and 20 of the first and second embodiments are selected as the representative of the holding member, but the same operations and effects could be obtained in other third to seventh embodiments.

As discussed above, the embodiment of the present invention can provide at least the following illustrative, non-limiting embodiments:

(1) A holding member for holding within a housing an exhaust gas treating element that treats an exhaust gas, wherein inorganic fiber sheet members are stacked to form at least two layers and the sheet member disposed on the back surface side is smaller in the width dimension in the gas inflow direction by a specific length than the sheet member disposed on the front surface side. Incidentally, the width dimension indicates the length in the axial direction of the exhaust gas treating element along the exhaust gas flow. Also, as for the back and front of the sheet member, the back surface side indicates the side coming into contact with the exhaust gas treating element when winding the sheet member on the exhaust gas treating element, and the front surface side indicates the opposite side (the side coming into contact with the housing at the installation in the housing).

According to the holding member described in (1), the holding member is press-fit into the housing, for example, at GBD of 0.5 g/cm³ or more that allows the start of fiber crush and therefore, the portion where the sheet members are stacked and overlapped in the diameter direction has a GBD of 0.5 g/cm³ or more at which fiber crush starts, but a surface pressure necessary for holding the exhaust gas treating element can be ensured. On the other hand, in the portion where sheet members are not stacked and not overlapped, because of one layer, the GBD becomes lower than in the two-layer portion and the fiber is thereby not damaged, so that an eolian erosion resistance performance can be ensured. As a result, the concern about eolian erosion in holding an exhaust gas treating element having a large weight can be eliminated and the design freedom can be elevated.

(2) The holding member in (1), wherein at least on the exhaust gas inflow side of the sheet member, the inflow-side end part of the sheet member having a larger width dimension is bent to the sheet member side having a smaller width dimension at the installation in the housing. Incidentally, the “bend” indicates a state of the sheet member being deformed into a folded or curved shape at least after installation in the housing.

According to the holding member in (2), the bent portion of the sheet member having a larger width dimension protruded from the sheet member having a smaller width dimension comes to have a low GBD and therefore, reduction in the eolian erosion resistance performance can be more prevented.

(3) The holding member in (1) or (2), wherein the sheet member having a larger width dimension is a needle-punched mat.

According to the holding member in (3), the sheet member having a larger width dimension is a needle-punched mat and therefore, an inorganic fiber is locally oriented by needling in the thickness direction of the seal member, so that the strength of the seal member can be more increased and the eolian erosion resistance can be more enhanced. Incidentally, the needling is preferably applied in an opposite manner from both sides of front surface and back surface of the seal member, whereby the strength of the holding member is more increased.

(4) A holding member for holding within a housing an exhaust gas treating element that treats an exhaust gas, by winding an inorganic fiber sheet member around the outer periphery of the exhaust gas treating element to form at least two layers, wherein the sheet member is singly formed and the width dimension in the gas inflow direction of the end part first wound around the exhaust gas treating element differs from the width dimension of the opposite end part by a specific length.

According to the holding member in (4), a single sheet member is wound around the exhaust gas treating element and the holding member is press-fit into the housing, for example, at GBD of 0.5 g/cm³ or more allowing the start of fiber crush, so that although the center portion of the two-layer structure along the axial direction of the exhaust gas treating element has a GBD of 0.5 g/cm³ or more at which fiber crush starts, a surface pressure necessary for holding the exhaust gas treating element can be ensured. On the other hand, in the end part portion having a substantially one-layer structure, the GBD becomes low and the fiber is not damaged, so that an eolian erosion resistance performance can be ensured. As a result, the concern about eolian erosion in holding an exhaust gas treating element having a large weight can be eliminated and the design freedom can be elevated.

(5) The holding member in (4), wherein the change in the width dimension of the sheet member is continuous reduction from a long-side end part to a short-side end part of opposite paired end parts in a spread (non-wound) state and the winding starts from the short-side end part.

According to the holding member in (5), the change in the width dimension is continuous reduction from the second layer portion to the first layer portion, so that the planar shape of the sheet member can be made to be, for example, a simple trapezoidal shape to afford excellent processability in forming the holding member. Furthermore, in the end part portion, the GBD becomes low and the fiber is not damaged, so that the eolian erosion performance can be enhanced.

(6) A holding member for holding within a housing an exhaust gas treating element that treats an exhaust gas, by winding an inorganic fiber sheet member around the outer periphery of the exhaust gas treating element to form at least two layers, wherein the sheet member is singly formed and the width dimension in the gas inflow direction of the end part first wound around the exhaust gas treating element is equal to the width dimension of the opposite end part.

According to the holding member in (6), the sheet member is spirally wound around the exhaust gas treating element while displacing the sheet member to form a specific displacement dimension in the axial direction of the exhaust gas treating element, and the holding member is press-fit into the housing, for example, at GBD 0.5 g/cm³ or more that allows the start of fiber crush. The center portion having a multilayer structure along the axial direction of the exhaust gas treating element comes to have a GBD of 0.5 g/cm³ or more at which fiber crush starts, but a surface pressure necessary for holding the exhaust gas treating element can be ensured. Furthermore, in the end part portion where the displacement dimension is set, the GBD becomes low and the fiber is not damaged, so that an eolian erosion resistance performance can be ensured. As a result, the concern about eolian erosion in holding an exhaust gas treating element having a large weight can be eliminated and the design freedom can be elevated.

(7) The holding member in (6), wherein the sheet member is formed in a rectangle or parallelogram shape.

According to the holding member in (7), the sheet member is formed in a rectangle or parallelogram shape, so that the production can be easy and the productivity can be enhanced.

(8) The holding member in (6) or (7), wherein the sheet member has a notch for forming a uniform face after wound around the exhaust gas treating element, in at lease one of the end part in the gas inflow direction and the end part in the gas outflow direction.

According to the holding member in (8), the sheet member when spirally wound around the exhaust gas treating element while displacing the sheet member to form a specific displacement dimension in the axial direction of the exhaust gas element is wound to create relatively parallel end faces without allowing protrusion of the end part by virtue of the notch.

(9) The holding member in any one of (1) to (8), wherein the sheet member contains a binder.

According to the holding member in (9), for example, an organic binder such as acrylic latex emulsion is used as the bonding material to bind the inorganic fiber as the main component by the organic binder, whereby flying of the fiber can be suppressed and the handleability by a worker can be enhanced.

(10) The holding member in any one of (1) to (9), wherein the inorganic fiber is a mixture of alumina and silica.

According to the holding member in (10), the inorganic fiber is formed by blending silica to alumina, whereby heat resistance can be enhanced and at the same time, an alumina-based precursor assured of eolian erosion resistance can be produced.

(11) An exhaust gas treating device comprising an exhaust gas treating element, a holding member wound around at least a part of the outer periphery of the exhaust gas treating element, and a housing for housing and holding the exhaust gas treating element wound with the holding member, wherein the holding member is obtained by stacking inorganic fiber sheet members to form at least two layers, the sheet member disposed on the back surface side is formed to be smaller in the width dimension in the gas inflow direction by a specific length than the sheet member disposed on the front surface side, and the end part of the sheet member disposed on the front surface side is deformed at the installation in the housing.

According to the exhaust gas treating device in (11), the portion where the sheet members are stacked and overlapped in the diameter direction has a GBD of 0.5 g/cm³ or more at which fiber crush starts, but a surface pressure necessary for holding the exhaust gas treating element can be ensured. Also, in the portion where sheet members are not stacked and not overlapped, because of one layer, the GBD becomes low and the fiber is not damaged, so that the eolian erosion resistance performance can be prevented from reduction. As a result, the concern about eolian erosion in holding an exhaust gas treating element having a large weight can be eliminated, high design freedom is enabled, and the exhaust gas treating property can be enhanced.

(12) An exhaust gas treating device comprising an exhaust gas treating element, a holding member used by winding an inorganic fiber sheet member around the outer periphery of the exhaust gas treating element to form at least two layers, and a housing for housing and holding the exhaust gas treating element wound with the holding member, wherein in the sheet member of the holding member, the width dimension in the gas inflow direction of the holding member end part first wound around the exhaust gas treating element differs from the width dimension of the opposite end part by a specific length, and the end part in the two-layer portion on the front surface side is deformed at the installation in the housing.

According to the exhaust gas treating device in (12), a single holding member is wound around the exhaust gas treating element and is press-fit into the housing, for example, at GBD of 0.5 g/cm³ or more allowing the start of fiber crush, so that although the center portion of the two-layer structure along the axial direction of the exhaust gas treating element has a GBD of 0.5 g/cm³ or more at which fiber crush starts, a surface pressure necessary for holding the exhaust gas treating element can be ensured. On the other hand, in the end part portion having a substantially one-layer structure, the GBD becomes low and the fiber is not damaged, so that an eolian erosion resistance performance can be ensured. As a result, the concern about eolian erosion in holding an exhaust gas treating element having a large weight can be eliminated, high design freedom is enabled, and the exhaust gas treating property can be enhanced.

(13) An exhaust gas treating device comprising an exhaust gas treating element, a holding member used by winding an inorganic fiber sheet member on the outer periphery of the exhaust gas treating element to form at least two layers, and a housing for housing and holding the exhaust gas treating element wound with the holding member, wherein the sheet member of the holding member is spirally wound around the exhaust gas treating element while displacing the sheet member to have a specific displacement dimension in the axial direction of the exhaust gas treating element.

According to the exhaust gas treating device in (13), after the sheet member is spirally wound around the exhaust gas treating element while displacing the sheet member to form a specific displacement dimension in the axial direction of the exhaust gas treating element, the holding member is press-fit into the housing, for example, at GBD 0.5 g/cm³ or more that allows the start of fiber crush. The center portion having a multilayer structure along the axial direction of the exhaust gas treating element comes to have a GBD of 0.5 g/cm³ or more at which fiber crush starts, but a surface pressure necessary for holding the exhaust gas treating element can be ensured. Furthermore, in the end part portion where the displacement dimension is set, the GBD becomes low and the fiber is not damaged, so that an eolian erosion resistance performance can be ensured. As a result, the concern about eolian erosion in holding an exhaust gas treating element having a large weight can be eliminated, high design freedom is enabled, and the exhaust gas treating property can be enhanced.

(14) The exhaust gas treating device in any one of (11) to (13), wherein the gap bulk density at the deformed end part of the sheet member disposed on the front surface side, after installation in the housing, is from 0.25 to 0.55 g/cm³, preferably from 0.3 to 0.5 g/cm³. If the gap bulk density is less than 0.25 g/cm³, the fiber is broken and flies apart resulting from movement due to low surface pressure. Also, if the GBD exceeds 0.55 g/cm³, the fiber becomes short resulting from breakage due to the surface pressure and flies apart.

According to the exhaust gas treating device in (14), the gap bulk density at the deformed end part of the sheet member disposed on the front surface side is from 0.3 to 0.5 g/cm³, so that a best eolian erosion resistance performance can be ensured.

(15) The exhaust gas treating device in any one of (11) to (14), wherein the exhaust gas treating element is a catalyst carrier or an exhaust gas filter.

According to the exhaust gas treating device in (15), the holding member can be applied to a catalyst carrier obtained by forming, for example, a ceramic material having high heat resistance, as typified by cordierite, alumina, mullite, spinel and the like, into a cylindrical honeycomb and loading a well-known three-way catalyst (for example, a platinum/rhodium/palladium catalyst) thereon. The holding member can also be applied to an exhaust gas filter obtained by forming a material having high heat resistance, such as ceramic material, into a porous cylindrical honeycomb. In this way, the holding member can be used as a holding member having high general-purpose applicability to both a gasoline engine and a diesel engine.

According to the holding member and exhaust gas treating device as described above, in a holding member for holding within a housing an exhaust gas treating element that treats an exhaust gas and in an exhaust gas treating device using the holding member, the concern about eolian erosion in holding an exhaust gas treating element having a large weight can be eliminated, high design freedom is enabled, and the exhaust gas treating property can be enhanced.

Obviously, numerous modifications and variations of the present invention are possible in light of the above teachings. It is therefore to be understood that within the scope of the appended claims, the invention may be practiced otherwise than as specifically described herein.

What is claimed is:

1. A holding member to hold in a housing an exhaust gas treating element through which an exhaust gas is configured to flow from an inlet to an outlet in a flowing direction, the holding member comprising:
a first inorganic fiber layer to be wrapped around the exhaust gas treating element, the first inorganic fiber layer having a first length along the flowing direction; and
a second inorganic fiber layer provided on the first inorganic fiber layer, the second inorganic fiber layer having a second length along the flowing direction which is longer than the first length.

2. The holding member according to claim 1, wherein the second inorganic fiber layer comprises an end part to be provided at a side of the inlet, the end part being bent to the first inorganic fiber layer when the holding member is provided in the housing.

3. The holding member according to claim 1, wherein the second inorganic fiber layer comprises a needle-punched mat.

4. A holding member to hold in a housing an exhaust gas treating element through which an exhaust gas is configured to flow from an inlet to an outlet in a flowing direction, the holding member comprising:
an inorganic fiber sheet having a first end part and a second end part opposite to the first end part along a longitudinal direction of the inorganic fiber sheet and to be wound from the first end part along the longitudinal direction around an outer periphery of the exhaust gas treating element to form at least two layers of the inorganic fiber sheet, the first end part having a first length along the flowing direction, the second end part having a second length along the flowing direction which is different from the first length.

5. The holding member according to claim 4, wherein the inorganic fiber sheet member has a length along the flowing direction which decreases continuously from the second end part to the first end part.

6. A holding member to hold in a housing an exhaust gas treating element through which an exhaust gas is configured to flow from an inlet to an outlet in a flowing direction, the holding member comprising:
an inorganic fiber sheet having a first end part and a second end part opposite to the first end part along a longitudinal direction of the inorganic fiber sheet and to be wound from the first end part along the longitudinal direction around an outer periphery of the exhaust gas treating element to form at least two layers of the inorganic fiber sheet, the first end part having a first length along the flowing direction, the second end part having a second length along the flowing direction which is substantially equal to the first length.

7. The holding member according to claim 6, wherein the inorganic fiber sheet has a rectangle shape or a parallelogram shape.

8. The holding member according to claim 6, wherein the inorganic fiber sheet comprises a notch at at least one of the first end part and the second end part so that an edge of the notch and an edge of a second layer of the inorganic fiber sheet are substantially leveled along the flowing direction when the inorganic fiber sheet is wound around the exhaust gas treating element.

9. The holding member according to claim 1, wherein the inorganic fiber sheet comprises a binder.

10. The holding member according to claim 1, wherein the inorganic fiber sheet comprises a mixture of alumina and silica.

11. An exhaust gas treating device comprising:
an exhaust gas treating element through which an exhaust gas is configured to flow from an inlet to an outlet in a flowing direction;
a housing which houses the exhaust gas treating element; and
a holding member wound around at least a part of an outer periphery of the exhaust gas treating element to hold the exhaust gas treating element in the housing, the holding member comprising:
a first inorganic fiber layer wound around the exhaust gas treating element, the first inorganic fiber layer having a first length along the flowing direction; and
a second inorganic fiber layer provided on the first inorganic fiber layer, the second inorganic fiber layer having a second length along the flowing direction which is longer than the first length, the second inorganic fiber layer having an end part provided at a side of the inlet, the end part being bent to the first inorganic fiber layer when the holding member is provided in the housing.

12. An exhaust gas treating device comprising:
an exhaust gas treating element through which an exhaust gas is configured to flow from an inlet to an outlet in a flowing direction;
a housing which houses the exhaust gas treating element; and
a holding member wound around at least a part of an outer periphery of the exhaust gas treating element to hold the exhaust gas treating element in the housing, the holding member comprising:
an inorganic fiber sheet having a first end part and a second end part opposite to the first end part along a longitudinal direction of the inorganic fiber sheet and wound from the first end part along the longitudinal direction around an outer periphery of the exhaust gas treating element to form at least two layers of the inorganic fiber sheet, the first end part having a first length along the flowing direction, the second end part having a second length along the flowing direction which is different from the first length, an end part of a second layer of the inorganic fiber sheet being deformed.

13. An exhaust gas treating device comprising:
an exhaust gas treating element through which an exhaust gas is configured to flow from an inlet to an outlet in a flowing direction;
a housing which houses the exhaust gas treating element; and
an inorganic fiber sheet spirally wound around the exhaust gas treating element to hold the exhaust gas treating element in the housing while an end portion along the flowing direction of the inorganic fiber sheet is displaced by a specific length toward an axis of the exhaust gas treating element.

14. The exhaust gas treating device according to claim 11, wherein the end part which is bent to the first inorganic fiber layer has a gap bulk density of at least about 0.25 g/cm³ and at most about 0.55 g/cm³.

15. The exhaust gas treating device according to claim 11, wherein the exhaust gas treating element comprises a catalyst carrier or an exhaust gas filter.

16. The holding member according to claim 8, wherein the inorganic fiber sheet comprises a binder.

17. The holding member according to claim 9, wherein the inorganic fiber sheet comprises a mixture of alumina and silica.

18. The exhaust gas treating device according to claim 11, wherein the end part which is bent to the first inorganic fiber layer has a gap bulk density of at least about 0.3 g/cm³ and at most about 0.5 g/cm³.

19. The exhaust gas treating device according to claim 13, wherein the end portion which is displaced toward the axis of the exhaust gas treating element has a gap bulk density of at least about 0.25 g/cm³ and at most about 0.55 g/cm³.

20. The exhaust gas treating device according to claim 13, wherein the end portion which is displaced toward the axis of the exhaust gas treating element has a gap bulk density of at least about 0.3 g/cm³ and at most about 0.5 g/cm³.
